(19) United States
(12) Patent Application Publication
(10) Pub. No.: US 2026/0299512 A1
(43) Pub. Date: Oct. 1, 2026

(54) IMAGE FORMING APPARATUS

(71) Applicant: BROTHER KOGYO KABUSHIKI KAISHA, Nagoya (JP)

(72) Inventors: Soma KATO, Nagoya (JP); Yusuke MIZUNO, Nagoya (JP); Yuichi HASEGAWA, Nagoya (JP)

(73) Assignee: BROTHER KOGYO KABUSHIKI KAISHA, Nagoya (JP)

(21) Appl. No.: 19/557,412

(22) Filed: Mar. 5, 2026

(30) Foreign Application Priority Data
Mar. 26, 2025 (JP) 2025-051883

(51) Int. Cl. G03G 21/20; G03G 15/20; G03G 21/16

(52) U.S. Cl. CPC G03G 21/206; G03G 15/2017; G03G 21/1633; G03G 2221/1639; G03G 2221/1645

(57) ABSTRACT

An image processing apparatus includes a main body housing including an opening, a cover, a process unit, a fuser, a first exhaust fan located at an upper position with respect to the fuser, a second exhaust fan located at a lower position with respect to the fuser, and a controller configured to execute a printing operation for forming an image on a sheet. The controller is configured to control the second exhaust fan to drive at a driving speed equal to or higher than a first speed when executing the printing operation in a state where the cover is closed, and control the second exhaust fan to drive at a second speed lower than the first speed when executing the printing operation in a state where the cover is open.

### REFERENCE TO RELATED APPLICATIONS

This application claims priority from Japanese Patent Application No. 2025-051883, filed on Mar. 26, 2025. The entire content of the priority application is incorporated herein by reference.

### BACKGROUND ART

Conventionally, an image forming apparatus including a main body housing having an opening, an openable/closable cover for covering and uncovering the opening, a process unit for forming a toner image on a sheet, a fuser for fixing the toner image onto the sheet, and an exhaust fan for exhausting air from the main body housing, is known. The image forming apparatus may print the image in a state where the cover is open.

According to this known image forming apparatus, the image may be printed in a state where the cover, which is located rearward from the fuser, is open to uncover the opening. However, when the image is printed in the state where the cover rearward from the fuser is open, an airflow by the exhaust fan may change as compared with a case where an image is printed with the cover closed. Specifically, when the cover is open to uncover the opening, air is drawn into the main body housing from the exposed opening, and the air heated by the fuser may flow into the main body housing, which may cause a problem such that a temperature in the process unit increases.

Therefore, when this known image forming apparatus prints an image in the state where the cover is open, the exhaust fan may be driven at a lower speed than in a case where the cover is closed so that a flow rate of the air flowing into the main body housing may be reduced, thereby suppressing the increase in the temperature of the process unit.

### SUMMARY

However, there may be a case where an image forming apparatus has a plurality of exhaust fans, and one of those exhaust fans is located below a fuser. In such a case, when an image is printed with the cover being open, air heated by the fuser may be drawn below the fuser by the exhaust fan located below and flow into the main body housing, which may increase a temperature in the main body housing.

In view of this technical issue, the present disclosure is advantageous in providing an image forming apparatus configured to suppress an increase in temperature in a main body housing while printing an image in a state where a cover is open.

According to an aspect of the present disclosure, an image processing apparatus includes a main body housing, a cover, a process unit, a fuser, a first exhaust fan, a second exhaust fan, and a controller. The main body housing includes an opening. The cover is configured to open and close the opening. The process unit includes a photosensitive drum configured to rotate about an axis and a developing device configured to supply a toner to the photosensitive drum. The process unit is configured to form an image with the toner on a sheet. The fuser is located between the cover and the process unit in a view along an axial direction of the photosensitive drum. The fuser is configured to heat the sheet, on which the image is formed with the toner, to fix the image onto the sheet. The first exhaust fan is configured to exhaust air in the main body housing. The first exhaust fan is located at an upper position with respect to the fuser in the view along the axial direction. The second exhaust fan is configured to exhaust air in the main body housing. The second exhaust fan is located at a lower position with respect to the fuser in the view along the axial direction. The controller is configured to execute a printing operation for forming the image on the sheet. The controller being configured to control the second exhaust fan to drive at a driving speed equal to or higher than a first speed when executing the printing operation in a state where the cover is closed, and control the second exhaust fan to drive at a second speed lower than the first speed when executing the printing operation in a state where the cover is open.

### BRIEF DESCRIPTION OF DRAWINGS

FIG. 1 is a cross-sectional view of an image forming apparatus with a rear cover at a closed position.

FIG. 2 is a cross-sectional view of the image forming apparatus with the rear cover at an open position.

FIG. 3 is a perspective view of the image forming apparatus.

FIG. 4 is an exploded perspective view of fans and a rightward frame.

FIG. 5 is a side view of a control board and the fans supported by the rightward frame.

FIG. 6 is a side view of a right-side wall of a main body housing of the image forming apparatus.

FIG. 7 is a side view of the rightward frame supporting the fans and an intake duct formed in the rightward frame.

FIG. 8 is a block diagram illustrating sensors and the fans connected to a controller.

FIG. 9 is a table illustrating a relationship between operating states of the image forming apparatus and driving speeds of the fans.

FIG. 10 is a table illustrating a relationship between conditions and driving speeds of a first exhaust fan for variable [1].

FIG. 11 is a table illustrating a relationship between conditions and driving speeds of a second exhaust fan for variable [2].

FIG. 12 is a flowchart illustrating an operation control of the second exhaust fan according to an open/close state of the rear cover.

FIG. 13 is a flowchart illustrating an operation control of the second exhaust fan for cooling down.

FIG. 14 is a table illustrating a relationship between conditions and driving speeds of the first exhaust fan for variable [3].

### DESCRIPTION

Hereinafter, an illustrative embodiment of the present application will be described in detail with reference to the drawings.

### Image Forming Apparatus

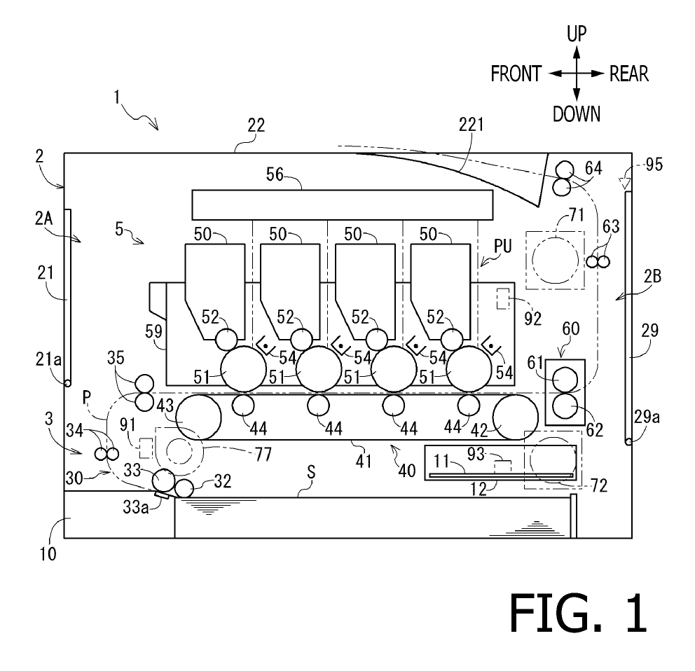

An image forming apparatus 1, as shown in FIGS. 1-3, according to the embodiment of the present disclosure is a color laser printer capable of forming images in a plurality of colors on a sheet S by an electrophotographic method.

In the following description, a left-hand side in FIG. 1 to a viewer is defined as a front side of the image forming apparatus 1, a right-hand side in FIG. 1 to the viewer is defined as a rear side of the image forming apparatus 1, a nearer side in FIG. 1 to the viewer is defined as a rightward side of the image forming apparatus 1, and a farther side in FIG. 1 to the viewer is defined as a leftward side of the image forming apparatus 1. An upper side and a lower side in FIG. 1 to the viewer are defined as an upper side and a lower side of the image forming apparatus 1, respectively.

The image forming apparatus 1 includes a main body housing 2, a sheet feeder 3 including a sheet tray 10 for supporting sheets S and a sheet conveyor 30 for conveying each sheet S, and an image forming device 5 forming an image on the sheet S conveyed by the sheet feeder 3.

The main body housing 2 is formed in a substantially rectangular parallelepiped box and accommodates the sheet feeder 3 and the image forming device 5. A front opening 2A is formed on a front face of the main body housing 2, and the main body housing 2 includes a front cover 21 configured to open or close the front opening 2A.

The front cover 21 is rotatable about a rotation shaft 21a at a lower end thereof, and is movable between a closed position where the front cover 21 closes the front opening 2A and an open position where the front cover 21 opens the front opening 2A by rotating about the rotation shaft 21a.

On a rear face of the main body housing 2, a rear opening 2B is formed, and the main body housing 2 includes a rear cover 29 configured to open or close the rear opening 2B. The rear opening 2B is an example of the opening in the main body housing 2. The rear cover 29 is an example of the cover configured to open and close the opening.

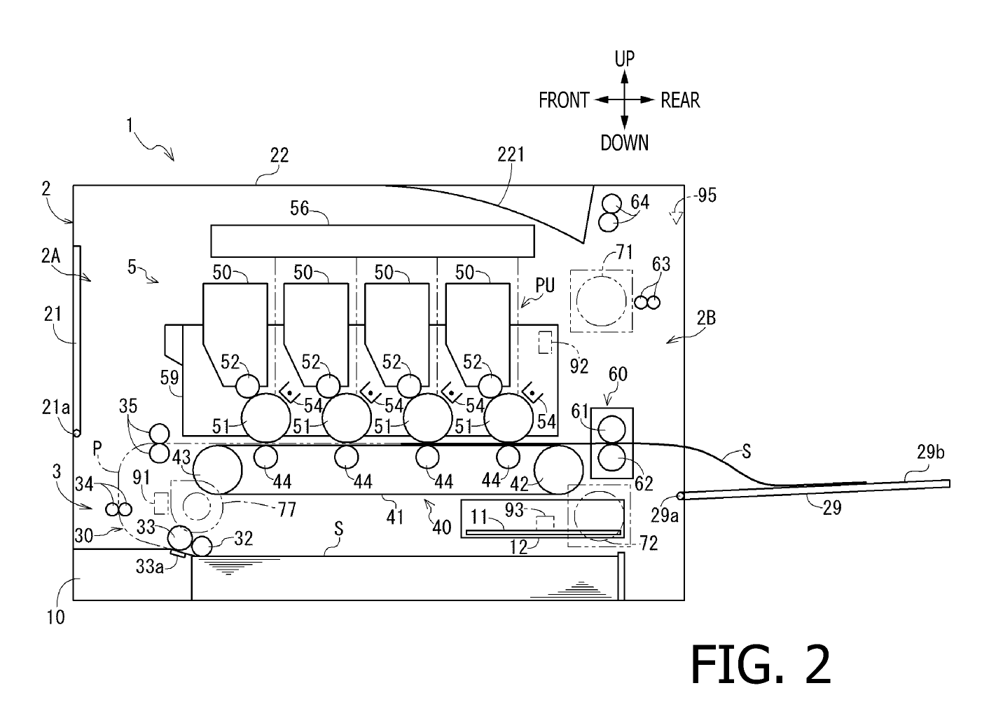

The rear cover 29 is rotatable about a rotation shaft 29a at a lower end thereof, and is movable between a closed position (position shown in FIG. 1) where the rear cover 29 closes the rear opening 2B and an open position (position shown in FIG. 2) where the rear cover 29 opens the rear opening 2B by rotating about the rotation shaft 29a.

On an upper face of the main body housing 2, a top cover 22 is disposed, and the top cover 22 includes a discharge tray 221 inclining downward from the front side toward the rear side.

The sheet feeder 3 is disposed in a lower area in the main body housing 2 and is configured to convey the sheet S supported by the sheet tray 10 to the image forming device 5 with the sheet conveyor 30. The sheet tray 10 is slidable in a front-rear direction, and is movable between a stowed position where the sheet tray 10 is stowed in the main body housing 2 and a separated position where the sheet tray 10 is pulled frontward from the stowed position.

The sheet conveyor 30 includes a feed roller 32, a separation roller 33, a separation pad 33a, a pair of conveyor rollers 34, and a pair of registration rollers 35. In the main body housing 2, a conveyor path P is formed for the sheet S to be conveyed from the sheet tray 10 to the discharge tray 221 via the image forming device 5.

The sheets S supported on the sheet tray 10 are separated one by one by the feed roller 32, the separation roller 33, and the separation pad 33a, and are forwarded to the conveyor path P. The feed roller 32 is a roller for conveying the sheet S from the sheet tray 10 toward the image forming device 5. The separation roller 33 and the separation pad 33a separate the sheets S supported on the sheet tray 10 individually.

The sheet S forwarded to the conveyor path P is conveyed toward the image forming device 5 by the pair of conveyor rollers 34 and the pair of registration rollers 35. The pair of registration rollers 35 regulate a movement of a leading end of the conveyed sheet S to stop temporarily and resume conveying the sheet S toward the image forming device 5 at a predetermined timing.

The image forming device 5 is disposed above the sheet feeder 3, and includes four process cartridges 50 arranged in parallel to the front-rear direction, and photosensitive drums 51 corresponding to respective process cartridges 50. The process cartridges 50 stores yellow, magenta, cyan, and black toner, respectively. The process cartridges 50 may be arranged from front toward rear in an order of yellow, magenta, cyan, and black. Each process cartridge 50 includes a developing roller 52. Note that the image forming device 5 is not necessarily limited to the multicolor image forming device but may be a monochrome image forming device having a single process cartridge 50 and a single photosensitive drum 51.

The process cartridges 50 are detachably supported by a drawer 59. The drawer 59 may be pulled out from the main body housing 2 through the front opening 2A in the main body housing 2 with the front cover 21 being open. The drawer 59 is movable between a first position where the drawer 59 is stowed inside the main body housing 2 and a second position where at least a part of the drawer 59 is located outside the main body housing 2.

Each photosensitive drum 51 is formed in a substantially cylindrical shape, of which axial direction coincides with a left-right direction. The photosensitive drums 51 are supported by the drawer 59 so as to be rotatable about respective axes extending along the left-right direction. That is, each photosensitive drum 51 rotates about its axis. The left-right direction is an example of the axial direction.

The developing rollers 52 extend in the left-right direction and are rotatably supported by the respective process cartridges 50. The developing rollers 52 in the process cartridges 50 supply toners to the respective photosensitive drums 51. The process cartridges 50 are an example of the developing device configured to supply a toner to the photosensitive drum.

The main body housing 2 includes an exposure device 56 for exposing a surface of the photosensitive drum 51. The exposure device 56 includes a laser diode, a polarizer, a lens, and a mirror, which are not shown. The exposure device 56 is configured to emit a light beam onto the photosensitive drums 51 to expose the surface of each photosensitive drum 51 with the light beam.

Below the photosensitive drum 51 across the conveyor path P, a transfer belt 41 is disposed to face the photosensitive drums 51. The transfer belt 41 is in contact with the photosensitive drums 51. The transfer belt 41 is wound around a driving roller 42 and a driven roller 43 which is disposed frontward with respect to the driving roller 42. Transfer rollers 44 are disposed at positions to face respective photosensitive drums 51 with the transfer belt 41 interposed therebetween. The belt unit 40 in the image forming device 5 includes the transfer belt 41, the driving roller 42, the driven roller 43, the transfer roller 44.

The image forming device 5 includes chargers 54 for charging the photosensitive drums 51. The chargers 54 are supported by the drawer 59. The photosensitive drums 51 charged uniformly by the respective chargers 54 are selectively exposed by the exposure device 56. By this exposure, charges are selectively removed from the surfaces of the photosensitive drums 51, and electrostatic latent images are formed on the surfaces of the photosensitive drums 51.

The toners stored in the process cartridges 50 are positively charged and carried on surfaces of the developing rollers 52, to which a developing bias is applied. When the electrostatic latent images formed on the photosensitive drums 51 face the respective developing rollers 52, the toners are supplied from the developing rollers 52 to the electrostatic latent images due to a potential difference between the electrostatic latent images and the developing rollers 52. As such, toner images are formed on the surfaces of the photosensitive drums 51.

When the sheet S conveyed toward the image forming device 5 reaches the transfer belt 41, the sheet S is conveyed by the transfer belt 41 and sequentially passes positions between the transfer belt 41 and the photosensitive drums 51. When the toner images carried on the surfaces of the respective photosensitive drums 51 face the sheet S, the toner images are transferred to the sheet S by a transfer bias applied to the transfer rollers 44.

The transfer belt 41 according to the present embodiment is configured as a conveyor belt that may convey the sheet S, to which the toner images are transferred; however, the transfer belt may optionally be configured as an intermediate transfer belt, on which the toner images are transferred, and the toner images transferred to the belt are further transferred to the sheet S.

The sheet S to which the toner images are transferred is conveyed to a fuser 60. The fuser 60 includes a heat roller 61 and a pressure roller 62 pressed against the heat roller 61. The toner images formed on the sheet S conveyed to the fuser 60 are thermally fixed thereon while the sheet S passes through a position between the heat roller 61 and the pressure roller 62. That is, the fuser 60 heats the sheet S and fixes the toner images onto the sheet S.

The sheet S on which the toner image is thermally fixed is conveyed downstream from the fuser 60 in a conveying direction. As shown in FIG. 1, when the rear cover 29 is at the closed position, the sheet S conveyed downstream from the fuser 60 in the conveying direction is conveyed by a pair of intermediate discharge rollers 63 and a pair of discharge rollers 64 disposed downstream of the pair of intermediate discharge rollers 63 in the conveying direction, and is discharged to the discharge tray 221.

On the other hand, as shown in FIG. 2, when the rear cover 29 is at the open position, the sheet S conveyed downstream from the fuser 60 in the conveying direction is discharged rearward from the main body housing 2 through the rear opening 2B. The sheet S discharged from the main body housing 2 rearward may rest on an optional tray 29b which is formed of an upper surface of the rear cover 29 at the open position. In other words, the rear cover 29 includes the optional tray 29b configured to support the sheet S discharged from the main body housing 2 in the state where the rear cover 29 is open.

In the image forming apparatus 1, a process unit PU for forming toner images on the sheet S includes the drawer 59, the process cartridges 50 supported by the drawer 59, the photosensitive drums 51, and the chargers 54. The process unit PU is an example of the process unit configured to form an image with the toner on a sheet. The fuser 60 is disposed between the rear cover 29 and the process unit PU in the view along the left-right direction.

Optionally, as long as the process unit PU includes at least the photosensitive drums 51 and the process cartridges 50, the process unit PU may include the transfer belt 41 or the fuser 60. Further, in the process unit PU, the drawer 59 may support the photosensitive drums 51 as in the present embodiment, or the process cartridges 50 may support the respective photosensitive drums 51.

The image forming apparatus 1 includes a power supply board 11 on which a power supply circuit is formed, and a board cover 12 covering the power supply board 11. The board cover 12 is disposed between the sheet tray 10 and the belt unit 40 at a rearward area in the main body housing 2. The board cover 12 is located below the fuser 60. The main body housing 2 accommodates the process unit PU and the board cover 12.

### Leftward Frame and Rightward Frame

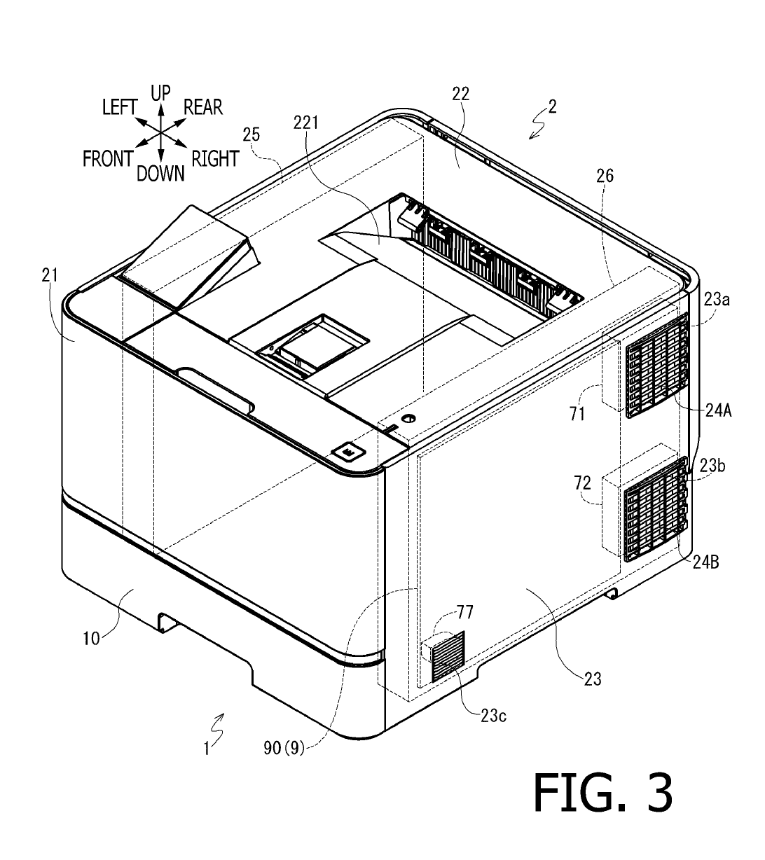

As shown in FIG. 3, the main body housing 2 accommodates a leftward frame 25 and a rightward frame 26. The leftward frame 25 and the rightward frame 26 are disposed apart from each other in the left-right direction. The leftward frame 25 is located at a leftward end region in the main body housing 2 and spreads in the front-rear direction and the up-down direction. The rightward frame 26 is located at a rightward end region in the main body housing 2 and spreads in the front-rear direction and the up-down direction.

### First Exhaust Fan and Second Exhaust Fan

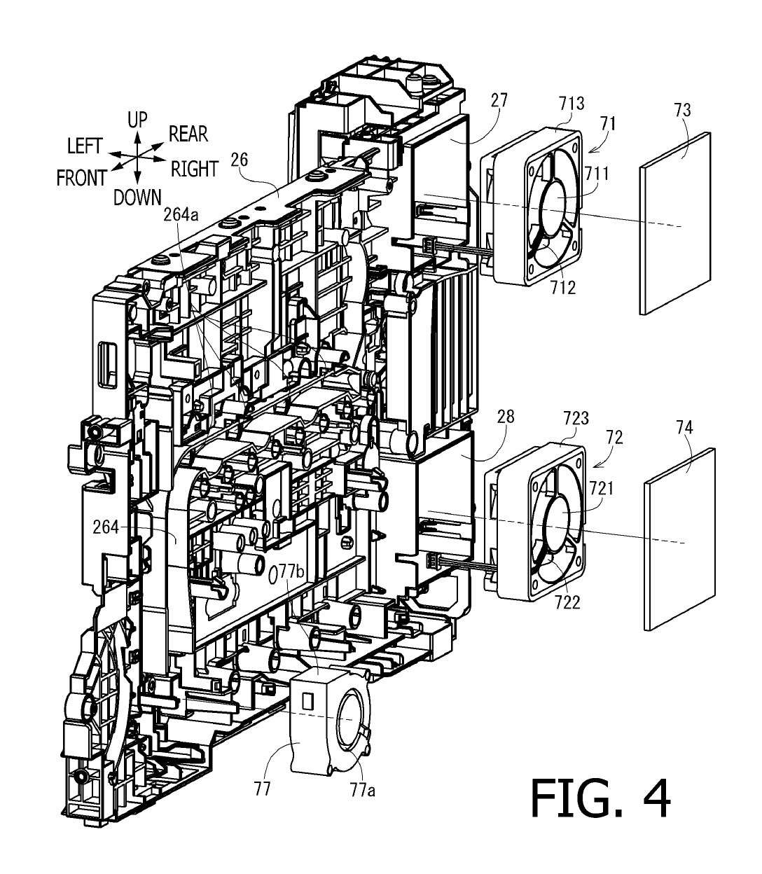

As shown in FIGS. 1-5, the image forming apparatus 1 includes a first exhaust fan 71 and a second exhaust fan 72 for exhausting air inside the main body housing 2 to an outside of the main body housing 2. The first exhaust fan 71 and the second exhaust fan 72 are examples of exhaust fans configured to exhaust air in the main body housing 2.

The first exhaust fan 71 is an axial fan including a rotation shaft 711 extending along the left-right direction, blades 712 fixed to the rotation shaft 711, and a case 713 supporting the rotation shaft 711 rotatably, and is configured to blow air outward along an axial direction of the rotation shaft 711. An exterior of the case 713 in the first exhaust fan 71 is formed in a square shape.

The first exhaust fan 71 is disposed rightward and rearward with respect to the process unit PU in the main body housing 2, and is configured to exhaust air, having been passed through the process unit PU and the fuser 60 in the main body housing 2, to the outside of the main body housing 2. Thereby, the air passed through the process unit PU and the fuser 60 may be effectively discharged by the first exhaust fan 71.

The first exhaust fan 71 is disposed between the process unit PU and the rear cover 29 located at the closed position in the view along the left-right direction. Moreover, the first exhaust fan 71 is located above the fuser 60 in the view along the left-right direction. Since the first exhaust fan 71 is located above the fuser 60, the air heated by the fuser 60 in the main body housing 2 may be effectively discharged to the outside of the main body housing 2 by the first exhaust fan 71.

The second exhaust fan 72 is an axial fan including a rotation shaft 721 extending along the left-right direction, blades 722 fixed to the rotation shaft 721, and a case 723 supporting the rotation shaft 721 rotatably, and is configured to blow air outward along an axial direction of the rotation shaft 721. An exterior of the case 723 in the second exhaust fan 72 is formed in a square shape.

The second exhaust fan 72 is disposed rightward with respect to the board cover 12 and the power supply board 11 in the main body housing 2. The second exhaust fan 72 is disposed at a position to overlap the board cover 12 and the power supply board 11 in the view along the left-right direction. The power supply board 11 is an example of the board located at a position to overlap the second exhaust fan in a view along the axial direction.

The second exhaust fan 72 is located below the first exhaust fan 71. The second exhaust fan 72 is configured to exhaust air in the board cover 12 in the main body housing 2 to the outside of the main body housing 2.

The second exhaust fan 72 is disposed between the process unit PU and the rear cover 29 located at the closed position in the view along the left-right direction. The second exhaust fan 72 is located below the fuser 60 in the view along the left-right direction. Since the second exhaust fan 72 is disposed below the fuser 60 and at the position to overlap the power supply board 11, heat generated in the power supply board 11 may be effectively discharged to the outside of the main body housing 2 by the second exhaust fan 72.

### Support for First Exhaust Fan and Second Exhaust Fan

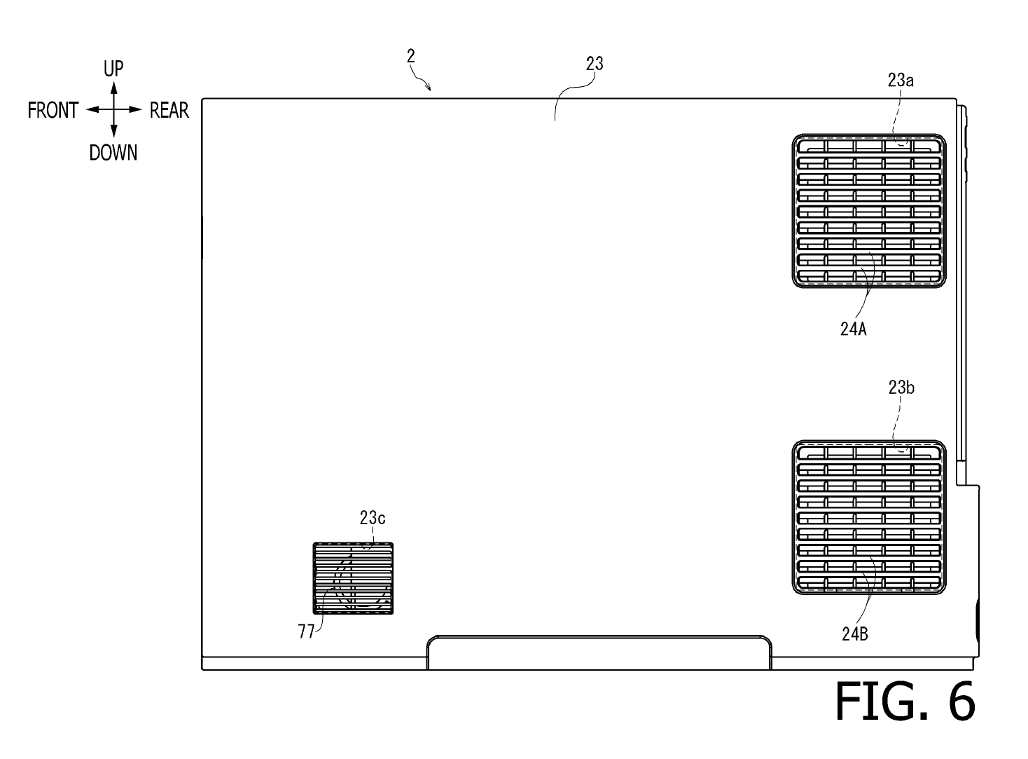

As shown in FIGS. 3-6, the main body housing 2 includes a right-side wall 23 covering a right side of the rightward frame 26. The right-side wall 23 includes a first opening 23a and a second opening 23b formed through the right-side wall 23 in the left-right direction. The first opening 23a and the second opening 23b are located rearward areas in the right-side wall 23, and the first opening 23a is located above the second opening 23b.

The rightward frame 26 includes a first fan duct 27 formed there-through in the left-right direction. The first fan duct 27 extends in the left-right direction and is configured to allow air to flow therein along the left-right direction. The first fan duct 27 is formed in a square shape in the view along the left-right direction. The first exhaust fan 71 is fitted in the first fan duct 27 and is supported by the rightward frame 26.

The first exhaust fan 71 is disposed at a position to overlap the first opening 23a in the view along the left-right direction. When the first exhaust fan 71 is driven, airflow in a direction from left toward right is generated, and the air in the process unit PU and the air around the fuser 60 are exhausted to the outside of the main body housing 2 through the first opening 23a by the airflow created by the first exhaust fan 71. The right-side wall 23 is disposed downstream of the first exhaust fan 71 in an exhaust direction of the first exhaust fan 71.

The rightward frame 26 includes a second fan duct 28 formed there-through in the left-right direction. The second fan duct 28 is located below the first fan duct 27. The second fan duct 28 extends in the left-right direction and is configured to allow air to flow therein along the left-right direction. The second fan duct 28 is formed in a square shape in the view along the left-right direction. The second exhaust fan 72 is fitted in the second fan duct 28 and is supported by the rightward frame 26.

The second exhaust fan 72 is disposed at a position to overlap the second opening 23b in the view along the left-right direction. When the second exhaust fan 72 is driven, airflow in the direction from left toward right is generated, and air in the board cover 12 is exhausted to the outside of the main body housing 2 through the second opening 23b by the airflow created by the second exhaust fan 72. The right-side wall 23 is disposed downstream of the second exhaust fan 72 in an exhaust direction of the second exhaust fan 72.

### First Louver and First Ozone Filter of First Exhaust Fan

The right-side wall 23 of the main body housing 2 includes a first louver 24A covering the first opening 23a. Through the first louver 24A, the inside and the outside of the main body housing 2 communicate. In the present embodiment, the first louver 24A is formed by being integrally molded with the right-side wall 23, but the first louver 24A may optionally be detachably attached to the right-side wall 23.

The first louver 24A is located rightward with respect to the first fan duct 27 and the first exhaust fan 71. That is, the first fan duct 27 and the first exhaust fan 71 are disposed on the inner side of the main body housing 2 with respect to the first louver 24A in the left-right direction.

The airflow from left to right caused by driving of the first exhaust fan 71 changes the exhaust direction thereof by passing through the first louver 24A. In the present embodiment, the exhaust direction of the air flowing from left to right is changed by the first louver 24A to an upper-rightward diagonal direction.

The image forming apparatus 1 includes a first exhaust filter 73 arranged between the first louver 24A and the first exhaust fan 71 in the left-right direction. The first exhaust filter 73 is supported by the right-side wall 23. The first exhaust filter 73 includes, for example, a honeycomb filter in which a filter material is formed in a honeycomb shape.

The filter material to form the first exhaust filter 73 may include, for example, paper supporting an ozone decomposition catalyst such as manganese dioxide or activated carbon, a metal such as aluminum, or ceramics. The first exhaust filter 73 is formed in a rectangular sheet shape.

In the main body housing 2, ozone is generated by a device that generates electrical discharge in the atmosphere, such as the chargers 54 provided to the process unit PU. Further, the toners stored in the process cartridge 50 may float in the main body housing 2.

The air in the process unit PU is suctioned rearward with respect to the process unit PU by the first exhaust fan 71, flows rightward, and passes through the first exhaust filter 73. Dust such as the toners is removed from the air passing through the first exhaust filter 73, and the air is exhausted to the outside of the main body housing 2 through the first louver 24A. Accordingly, dust to be contained in the air passed through the process unit PU and exhausted by the first exhaust fan 71 may be reduced.

Moreover, air around the fuser 60 stowed in the main body housing 2 is heated by the heat roller 61 and tends to rise from the area around the fuser 60. The air heated and moving upward from the area around the fuser 60 is suctioned by the first exhaust fan 71, flows rightward, passes through the first exhaust filter 73 to have dust removed, and is exhausted to the outside of the main body housing 2 through the first louver 24A.

By exhausting the air around the fuser 60 to the outside of the main body housing 2 by the first exhaust fan 71, the heat in the vicinity of the fuser 60 may be discharged, and a temperature in the area around the fuser 60 may be lowered.

Note that the first exhaust filter 73 may be any filter as long as the first exhaust filter 73 is capable of removing at least dust such as the toners from the air. Optionally, for example, an ozone filter, which is capable of collecting and removing dust such as the toners, and further capable of decomposing ozone in the air, may be used as the first exhaust filter 73.

### Second Louver and Second Ozone Filter of Second Exhaust Fan

The right-side wall 23 of the main body housing 2 includes a second louver 24B covering the second opening 23b. Through the second louver 24B, the inside and the outside of the main body housing 2 communicate. In the present embodiment, the second louver 24B is formed by being integrally molded with the right-side wall 23, but the second louver 24B may optionally be detachably attached to the right-side wall 23.

The second louver 24B is located rightward with respect to the second fan duct 28 and the second exhaust fan 72. That is, the second fan duct 28 and the second exhaust fan 72 are disposed on the inner side of the main body housing 2 with respect to the second louver 24B in the left-right direction.

The airflow from left to right caused by driving of the second exhaust fan 72 changes the exhaust direction thereof by passing through the second louver 24B. In the present embodiment, the exhaust direction of the air flowing from left to right is changed by the second louver 24B to an upper-rightward diagonal direction.

The image forming apparatus 1 includes a second exhaust filter 74 arranged between the second louver 24B and the second exhaust fan 72 in the left-right direction. The second exhaust filter 74 is supported by the right-side wall 23. The second exhaust filter 74 includes, for example, a honeycomb filter in which a filter material is formed in a honeycomb shape.

The filter material to form the second exhaust filter 74 may include, for example, paper supporting an ozone decomposition catalyst such as manganese dioxide or activated carbon, a metal such as aluminum, or ceramics. The second exhaust filter 74 is formed in a rectangular sheet shape.

The air in the board cover 12 stowed in the main body housing 2 is heated by electronic devices mounted on the power supply board 11 and a temperature of the air is likely to increase. The air in the board cover 12 flows from left to right by the second exhaust fan 72, and after ozone and dust are removed through the second exhaust filter 74, the air is exhausted to the outside of the main body housing 2 through the second louver 24B.

By exhausting the air in the board cover 12 to the outside of the main body housing 2 by the second exhaust fan 72, a temperature of the air in the board cover 12 may be lowered. Moreover, dust to be contained in the air in the main body housing 2 may be reduced.

Note that the second exhaust filter 74 may be any filter as long as the second exhaust filter 74 is capable of removing at least dust such as the toners from the air. Optionally, for example, an ozone filter, which is capable of collecting and removing dust such as the toners, and further capable of decomposing ozone in the air, may be used as the second exhaust filter 74.

### Intake Fan

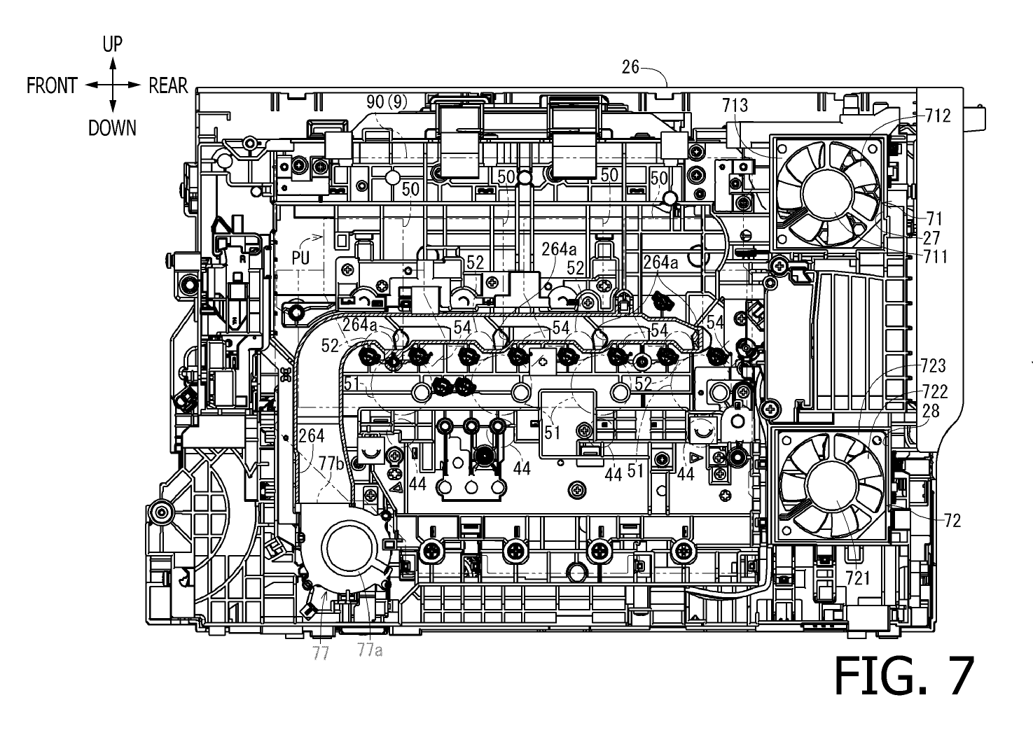

As shown in FIGS. 3, 4, and 7, the right-side wall 23 includes an intake port 23c formed through the right-side wall 23 in the left-right direction. Air outside the main body housing 2 may flow into the main body housing 2 through the intake port 23c. The image forming apparatus 1 includes an intake fan 77 disposed inside the right-side wall 23 and configured to draw the air outside the main body housing 2 into the main body housing 2. The intake fan 77 is disposed at a rightward end and lower-frontward area in the main body housing 2.

By driving the intake fan 77, air from the outside of the main body housing 2 is suctioned to the inside of the main body housing 2 through the intake port 23c. As such, the interior of the main body housing 2 may be cooled by the air drawn inside the main body housing 2, and the temperature in the main body housing 2 may be suppressed from increasing.

The intake fan 77 is supported on a rightward surface of the rightward frame 26. The intake fan 77 includes, for example, a centrifugal fan in which air is suctioned in an axial direction of a rotation shaft and is exhausted in a centrifugal direction orthogonal to the axial direction of the rotation shaft. The intake fan 77 is disposed in the main body housing 2 in a posture in which the axial direction of the rotation shaft coincides with the left-right direction, and air outside the main body housing 2 is suctioned into the main body housing 2 through the intake port 23c by the intake fan 77.

The intake fan 77 includes an intake section 77a for suctioning air and an exhaust section 77b for discharging the air. The intake section 77a faces the intake port 23c of the right-side wall 23. The exhaust section 77b is located at an upper end area in the intake fan 77 and exhausts the air upward.

On the right-side surface of the rightward frame 26A, an intake duct 264 is formed. The intake duct 264 is an intake passage for guiding the air taken in by the intake fan 77 to the process unit PU. The intake duct 264 extends upward from the exhaust section 77b of the intake fan 77 and extends rearward.

In a portion of the rightward frame 26 where the intake duct 264 is formed, intake holes 264a are formed through the rightward frame 26 in the left-right direction. The intake holes 264a are formed at four locations corresponding to the process cartridges 50 and the photosensitive drums 51 arranged in parallel in the front-rear direction.

The air suctioned from the outside of the main body housing 2 by the intake fan 77 is guided along the rightward surface of the rightward frame 26 by the intake duct 264 and flows out leftward through the intake holes 264a. The air flowing out leftward from the intake holes 264a reaches the process unit PU located inside the main body housing 2 with respect to the rightward frame 26.

As such, the intake duct 264 guides the air taken in by the intake fan 77 to the process unit PU along the left-right direction. The process unit PU may be cooled by guiding the air taken in by the intake fan 77 to the process unit PU. The intake duct 264 is an example of the duct configured to guide air drawn into the main body housing to the process unit along the axial direction. Further, by guiding the air drawn in by the intake fan 77 to the process unit PU, air may be supplied to the chargers 54, to which a high voltage is applied.

### Control Board and Controller

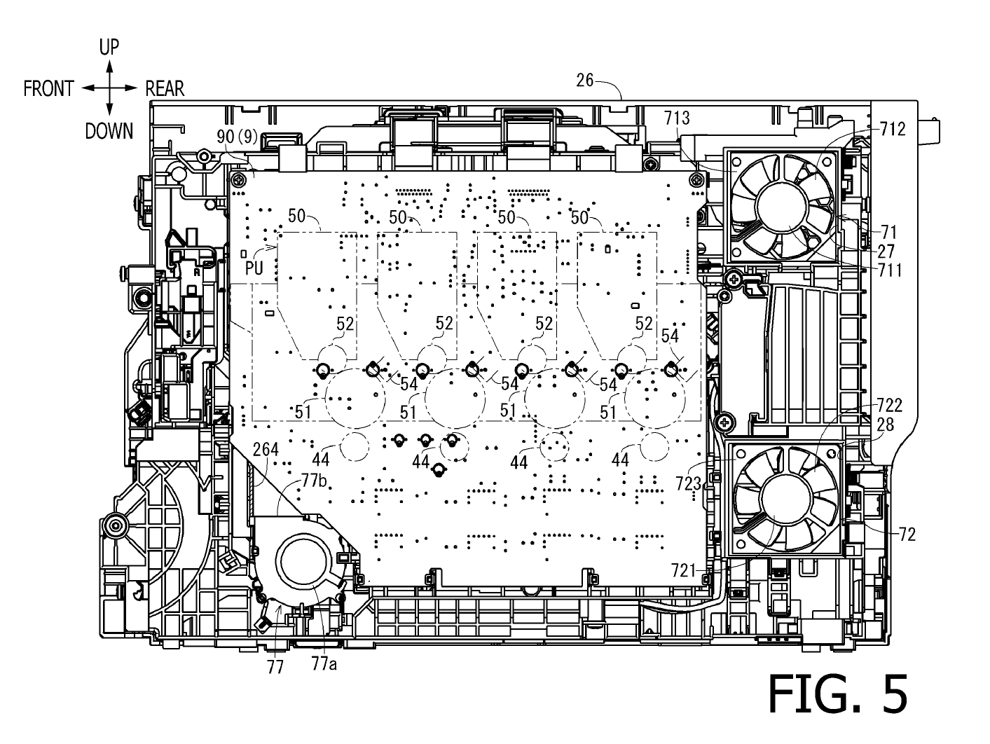

As shown in FIG. 5, a control board 90 is supported on the rightward surface of the rightward frame 26. The control board 90 includes a controller 9 for controlling operations of the image forming apparatus 1. The controller 9 includes, for example, a CPU, a RAM, a ROM, and an input/output circuit. The controller 9 is capable of controlling operations of, for example, the sheet feeder 3, the image forming device 5, and the fuser 60 of the image forming apparatus 1 by performing various arithmetic processes based on, for example, programs and data stored in, for example, the ROM.

The controller 9 is further capable of executing a printing operation for forming an image on a sheet S in the image forming apparatus 1. Furthermore, the controller 9 is capable of controlling operations of the first exhaust fan 71, the second exhaust fan 72, and the intake fan 77.

### Sensors

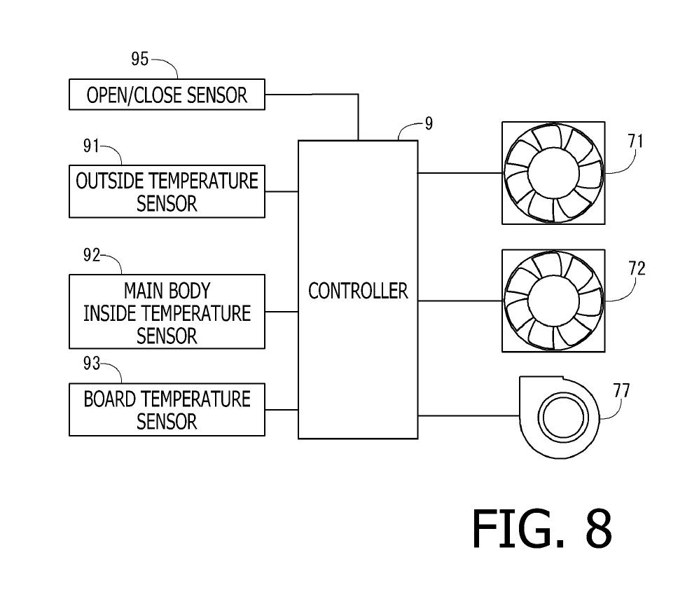

As shown in FIGS. 1 and 8, the image forming apparatus 1 includes an outside temperature sensor 91, a main body inside temperature sensor 92, a board temperature sensor 93, and an open/close sensor 95. The outside temperature sensor 91, the main body inside temperature sensor 92, the board temperature sensor 93, and the open/close sensor 95 are connected to the controller 9. The board temperature sensor 93 is an example of a sensor configured to detect a temperature of a board.

The outside temperature sensor 91 is a sensor for detecting a temperature outside the main body housing 2. The outside temperature sensor 91 is supported, for example, by a front lower portion of the rightward frame 26 in the main body housing 2, and detects a temperature of air outside the main body housing 2 drawn through the intake port 23c of the right-side wall 23. The outside temperature sensor 91 may be, for example, a thermistor. The controller 9 uses the temperature detected by, for example, the outside temperature sensor 91 as an outside temperature Tout.

The main body inside temperature sensor 92 is a sensor for detecting a temperature inside the main body housing 2. The main body inside temperature sensor 92 is disposed, for example, between the process cartridge 50 located at a most downstream position in the conveying direction of the sheet S and the fuser 60 in the main body housing 2. The main body inside temperature sensor 92 may be, for example, a thermistor. The controller 9 calculates a main body inside temperature Tin by using, for example, the temperature detected by the outside temperature sensor 91, the temperature detected by the main body inside temperature sensor 92, and operating states of the process unit PU and the fuser 60.

The main body inside temperature Tin is a temperature used for cooling control of the temperature in the main body housing 2 including the process unit PU. As the main body inside temperature Tin, the temperature detected by the main body inside temperature sensor 92 as it is may be used.

The board temperature sensor 93 is a sensor for detecting a temperature of the power supply board 11. The board temperature sensor 93 is mounted, for example, on the power supply board 11. The board temperature sensor 93 may be, for example, a thermistor. The controller 9 uses, for example, the temperature detected by the board temperature sensor 93 as a board temperature Tcb.

The open/close sensor 95 is a sensor for detecting the rear cover 29. The open/close sensor 95 is disposed at an upper-rearward end area in the main body housing 2, and detects the rear cover 29 located at the closed position. The open/close sensor 95 does not detect the rear cover 29 when the rear cover 29 is at the open position. The controller 9 determines that the rear cover 29 is at the closed position when the open/close sensor 95 detects the rear cover 29, and determines that the rear cover 29 is at the open position when the open/close sensor 95 does not detect the rear cover 29.

### Operation Control of Fans

The first exhaust fan 71, the second exhaust fan, and the intake fan 77 are connected to the controller 9. The controller 9 is capable of controlling operations of the first exhaust fan 71, the second exhaust fan 72, and the intake fan 77 in accordance with the outside temperature Tout, the main body inside temperature Tin, the board temperature Tcb, and the open/closed state of the rear cover 29.

The controller 9 is capable of setting a driving speed of the first exhaust fan 71 to, for example, a high speed V1A, a low speed V1C, or a stop V1D by controlling the operation of the first exhaust fan 71. The high speed V1A is a driving speed higher than the low speed V1C. The stop V1D is a stopped state where the driving speed is zero, and is lower than the high speed V1A and the low speed V1C.

As such, the controller 9 may drive the first exhaust fan 71 at the high speed V1A or the low speed V1C, or may set the driving speed of the first exhaust fan 71 to the stop V1D by stopping driving of the first exhaust fan 71.

The controller 9 is capable of setting the driving speed of the second exhaust fan 72 to, for example, a high speed V2A, a medium speed V2B, a low speed V2C, and a stop V2D by controlling the operation of the second exhaust fan 72. The high speed V2A is a driving speed higher than the low speed V2C and the medium speed V2B. The medium speed V2B is a driving speed higher than the low speed V2C. The stop V2D is a state where the driving speed is zero, which is lower than the high speed V2A, the medium speed V2B, and the low speed V2C.

The low speed V2C is an example of the first speed, and the stop V2D is an example of the second speed lower than the first speed.

As such, the controller 9 may drive the second exhaust fan 72 at the high speed V2A, the medium speed V2B, or the low speed V2C, or may set the driving speed of the second exhaust fan 72 to the stop V2D by stopping the driving of the second exhaust fan 72.

The controller 9 may set the driving speed of the intake fan 77 to, for example, a high speed V3A and a stop V3D by controlling the operation of the intake fan 77. The high speed V3A is a driving speed higher than the stop V3D. The stop V3D is a stopped state where the driving speed is zero, and is lower than the high speed V3A.

As such, the controller 9 may drive the intake fan 77 at the high speed V3A, or may set the driving speed of the intake fan 77 to the stop V3D by stopping the driving of the intake fan 77.

The high speed V1A, the low speed V1C, and the stop V1D of the first exhaust fan 71 represent relative magnitudes of the driving speed of the first exhaust fan 71. The high speed V2A, the medium speed V2B, the low speed V2C, and the stop V2D of the second exhaust fan 72 represent relative magnitudes of the driving speed of the second exhaust fan 72. The high speed V3A and the stop V3D of the intake fan 77 represent relative magnitudes of the driving speed of the intake fan 77.

Therefore, absolute magnitudes of the driving speeds among the high speed V1A of the first exhaust fan 71, the high speed V2A of the second exhaust fan 72, and the high speed V3A of the intake fan 77 do not necessarily coincide with one another. In other words, the high speed V1A, the high speed V2A, and the high speed V3A may have a same magnitude or may have different magnitudes. Further, absolute magnitudes of the driving speeds among the low speed V1C of the first exhaust fan 71 and the low speed V2C of the second exhaust fan 72 do not necessarily coincide with each other. In other words, the low speed V1C and the low speed V2C may have a same magnitude or may have different magnitudes.

### Operation Control of First Exhaust Fan During Printing Operation

The controller 9 controls operations of the first exhaust fan 71 as follows when printing an image.

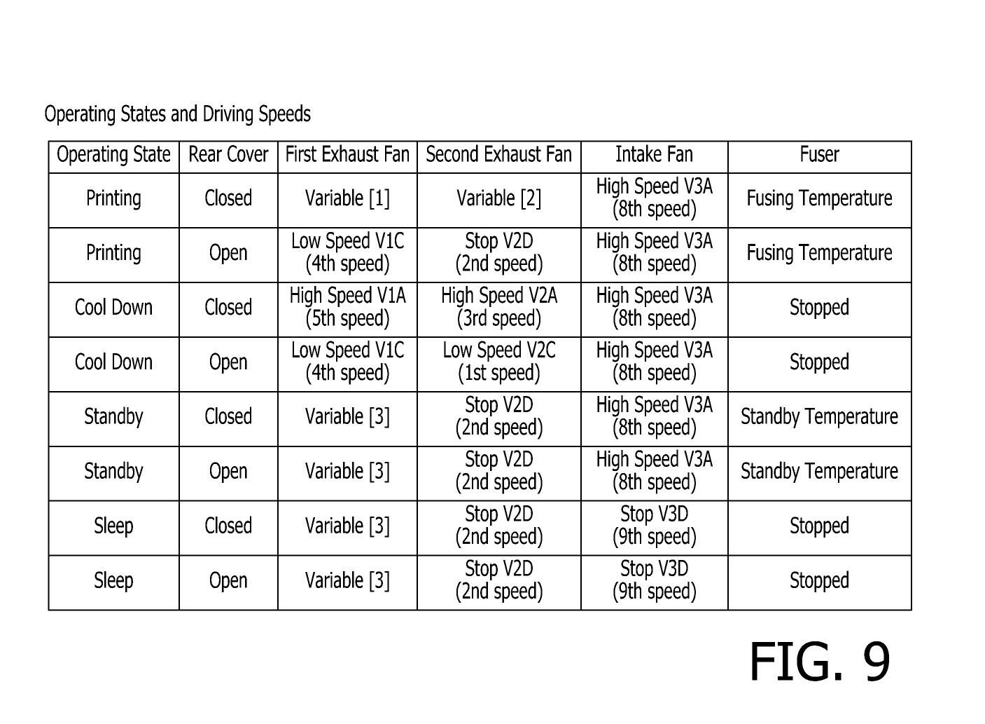

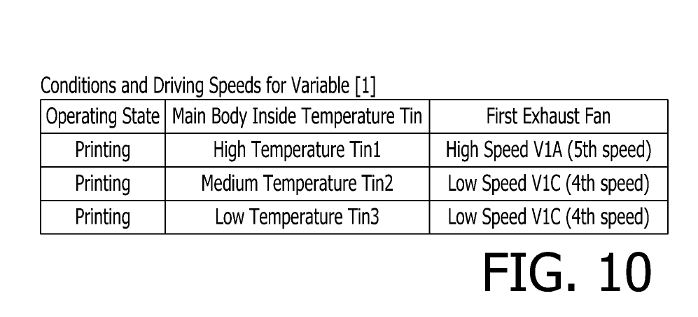

As shown in FIGS. 9-10, when the controller 9 determines that the rear cover 29 is at the closed position while executing the printing operation, the controller 9 controls the operation of the first exhaust fan 71 so as to change the driving speed in accordance with the main body inside temperature Tin (condition of variable 1 in FIG. 10). Meanwhile, when the controller 9 is executing the printing operation, the fuser 60 is in a state being heated to a fusing temperature.

Specifically, when the main body inside temperature Tin is a high temperature Tin1, the controller 9 sets the driving speed of the first exhaust fan 71 to the high speed V1A. When the main body inside temperature Tin is a medium temperature Tin2, the controller 9 sets the driving speed of the first exhaust fan 71 to the low speed V1C. When the main body inside temperature Tin is a low temperature Tin3, the controller 9 sets the driving speed of the first exhaust fan 71 to the low speed V1C.

In this context, the high temperature Tin1 is a temperature higher than the medium temperature Tin2, and the medium temperature Tin2 is a temperature higher than the low temperature Tin3.

As such, when the main body inside temperature Tin is the high temperature Tin1, which is higher than the medium temperature Tin2 and the low temperature Tin3, by setting the driving speed of the first exhaust fan 71 to the high speed V1A, which is higher than the low speed V1C, the temperature inside the main body housing 2 including the process unit PU may be lowered effectively.

Note that, in the present embodiment, the controller 9 sets the driving speed of the first exhaust fan 71 to the high speed V1A when the main body inside temperature Tin is the high temperature Tin1, but the driving speed in this occasion is not limited to this. That is, when the main body inside temperature Tin is the high temperature Tin1, the controller 9 may set the driving speed of the first exhaust fan 71 to a speed between the high speed V1A and the low speed V1C and higher than the low speed V1C.

When the main body inside temperature Tin is the medium temperature Tin2, the controller 9 sets the driving speed of the first exhaust fan 71 to the low speed V1C, but the driving speed in this occasion is not limited to this. That is, when the main body inside temperature Tin is the medium temperature Tin2, the controller 9 may set the driving speed of the first exhaust fan 71 to a speed equal to or lower than the driving speed of the first exhaust fan 71 in the case where the temperature is the high temperature Tin1 and equal to or higher than the low speed V1C in the case where the temperature is the high temperature Tin1.

When the main body inside temperature Tin is the low temperature Tin3, the controller 9 sets the driving speed of the first exhaust fan 71 to the low speed V1C, but the driving speed in this occasion is not limited to this. That is, when the main body inside temperature Tin is the low temperature Tin3, the controller 9 may set the driving speed of the first exhaust fan 71 to a speed equal to or lower than the driving speed of the first exhaust fan 71 in the case where the temperature is the medium temperature Tin2 and equal to or higher than the low speed V1C in the case where the temperature is the medium temperature Tin2.

On the other hand, when the controller 9 determines that the rear cover 29 is at the open position while executing the printing operation, the controller 9 controls the first exhaust fan 71 to drive at the low speed V1C.

When the driving speed of the first exhaust fan 71 is set to the high speed V1A in the state where the rear cover 29 is at the open position, a flow rate of the air flowing into the main body housing 2 from the rear opening 2B increases. As the air flow into the main body housing 2 from the rear opening 2B and passes near the fuser 60, the air is heated and then flows into the process unit PU that transfers the toner images to the sheet S. Accordingly, the temperature in the process unit PU may increase, causing the temperature in the main body housing 2 to increase.

However, when the rear cover 29 is at the open position, the controller 9 controls the first exhaust fan 71 to drive at the low speed V1C; therefore, a flow rate of the heated air flowing into the main body housing 2 decreases, and the increase of the temperature in the main body housing 2 may be suppressed.

As such, when executing a printing operation in the state where the rear cover 29 is closed, the controller 9 sets the driving speed of the first exhaust fan 71 to a speed, which is between the low speed V1C and the high speed V1A higher than the low speed V1C and is changed in accordance with the main body inside temperature Tin, and when executing a printing operation in the state where the rear cover 29 is open, the controller 9 sets the driving speed of the first exhaust fan 71 to the low speed V1C. Accordingly, the heated air may be prevented from flowing into the main body housing 2.

### Operation Control of Second Exhaust Fan During Printing Operation

The controller 9 controls an operation of the second exhaust fan 72 as follows when printing an image.

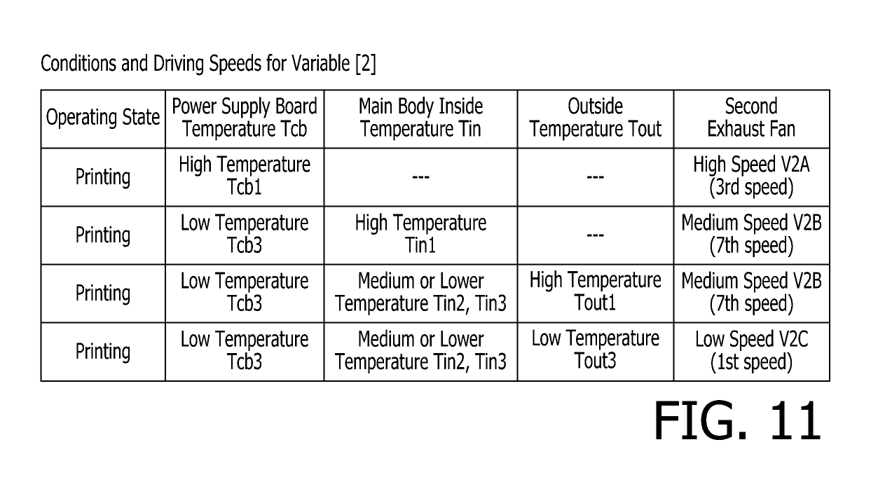

As shown in FIGS. 9-10, when the controller 9 determines that the rear cover 29 is at the closed position while executing the printing operation, the controller 9 controls the operation of the second exhaust fan 72 so as to change the driving speed in accordance with the board temperature Tcb, the main body inside temperature Tin, and the outside temperature Tout (condition of variable 2 in FIG. 11).

Under this condition, the controller 9 controls the operation of the second exhaust fan 72 to drive at a driving speed equal to or higher than the low speed V2C. That is, the controller 9 sets the driving speed of the second exhaust fan 72 to the low speed V2C or higher when executing the printing operation in the state where the rear cover 29 is closed. Further, the controller 9 changes the driving speed of the second exhaust fan 72 in a range between the low speed V2C and the high speed V2A. Meanwhile, when the controller 9 is executing the printing operation, the fuser 60 is in a state heated to the fusing temperature.

Specifically, when the board temperature Tcb is a high temperature Tcb1, the controller 9 sets the driving speed of the second exhaust fan 72 to the high speed V2A regardless of the main body inside temperature Tin and the outside temperature Tout. When the board temperature Tcb is a low temperature Tcb3 and the main body inside temperature Tin is the high temperature Tin1, the controller 9 sets the driving speed of the second exhaust fan 72 to the medium speed V2B regardless of the outside temperature Tout.

When the board temperature Tcb is the low temperature Tcb3, the main body inside temperature Tin is a medium temperature Tin2 or a low temperature Tin3, and the outside temperature Tout is a high temperature Tout1; the controller 9 sets the driving speed of the second exhaust fan 72 to the medium speed V2B. When the board temperature Tcb is the low temperature Tcb3, the main body inside temperature Tin is the medium temperature Tin2 or the low temperature Tin3, and the outside temperature Tout is a low temperature Tout3; the controller 9 sets the driving speed of the second exhaust fan 72 to the low speed V2C.

In this context, the high temperature Tcb1 is a temperature higher than the low temperature Tcb3. Moreover, the high temperature Tout1 is a temperature higher than the low temperature Tout3.

When the board temperature Tcb is the high temperature Tcb1 higher than the low temperature Tcb3, by setting the driving speed of the second exhaust fan 72 to the high speed V2A higher than the medium speed V2B and the low speed V2C, heat generated in the power supply board 11 may be effectively exhausted to the outside of the main body housing 2 by the second exhaust fan 72. Accordingly, an increase of the temperature in the main body housing 2 including the power supply board 11 may be suppressed.

Further, even when the board temperature Tcb is the low temperature Tcb3, when the main body inside temperature Tin is the high temperature Tin1 higher than the medium temperature Tin2 and the low temperature Tin3, by setting the driving speed of the second exhaust fan 72 to the medium speed V2B higher than the low speed V2C, an increase of the temperature in the main body housing 2 including the power supply board 11 may be suppressed.

Furthermore, even when the board temperature Tcb is the low temperature Tcb3 and the main body inside temperature Tin is the medium temperature Tin2 or the low temperature Tin3, if the outside temperature Tout is the high temperature Tout1, by setting the driving speed of the second exhaust fan 72 to the medium speed V2B higher than the low speed V2C, an increase of the temperature in the main body housing 2 including the power supply board 11 due to an influence of the outside temperature Tout may be suppressed.

Moreover, when the board temperature Tcb is the low temperature Tcb3, the main body inside temperature Tin is the medium temperature Tin2 or the low temperature Tin3, and the outside temperature Tout is the low temperature Tout3; by setting the driving speed of the second exhaust fan 72 to the low speed V2C, power consumption of the image forming apparatus 1 may be suppressed.

As such, when executing the printing operation in the state where the rear cover 29 is closed, an increase of the temperature of the power supply board 11 may be suppressed by the controller 9 capable of changing the driving speed of the second exhaust fan 72 in the range between the low speed V2C and the high speed V2A in accordance with the board temperature Tcb.

On the other hand, when the controller 9 determines that the rear cover 29 is at the open position while executing the printing operation, the controller 9 controls the second exhaust fan 72 so that the second exhaust fan 72 drives at the driving speed of stop V2D.

When the second exhaust fan 72 is driven at a driving speed equal to or higher than the low speed V1C in the state where the rear cover 29 is at the open position, air flows into the main body housing 2 from the rear opening 2B. As the air flows into the main body housing 2 from the rear opening 2B and passes near the fuser 60, the air is heated and then flows into the area below the fuser 60 in the main body housing 2. Accordingly, the temperature of the area below the fuser 60 in the main body housing 2 may increase.

However, when the printing operation is executed in the state where the rear cover 29 is at the open position, the controller 9 controls the second exhaust fan 72 to stop driving so that the driving speed matches the stopV2D; therefore, the air heated by the fuser 60 may be suppressed from flowing into the area below the fuser 60 in the main body housing 2. Accordingly, an increase of the temperature in the main body housing 2 may be suppressed.

In the present embodiment, when executing the printing operation in the state where the rear cover 29 is open, the operation of the second exhaust fan 72 is controlled so that the driving speed matches the stop V2D, but optionally, the controller 9 may be configured to drive the second exhaust fan 72 at a speed lower than the low speed V2C. Even when the driving speed of the second exhaust fan 72 is controlled at a speed lower than the low speed V2C, the controller 9 may suppress an increase of the temperature in the main body housing 2 as compared with a case where the driving speed of the second exhaust fan 72 is controlled at the low speed V2C.

In this regard, however, the flow of the air heated by the fuser 60 may be prevented from flowing into the area below the fuser 60 in the main body housing 2 more effectively by controlling the driving speed of the second exhaust fan 72 at the stop V2D.

Further, when starting the printing operation and while executing the printing operation, the controller 9 may determine the open/closed state of the rear cover 29 and control the operation of the second exhaust fan 72 in accordance with the determined open/closed state of the rear cover 29.

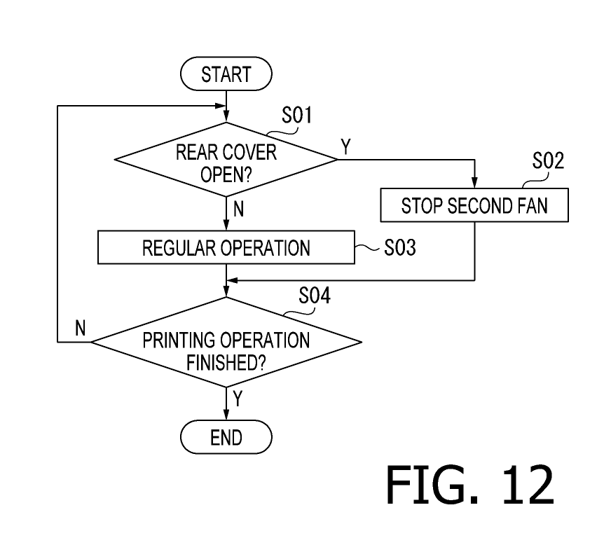

As shown in FIG. 12, the controller 9 determines whether the rear cover 29 is at the open position or the closed position when starting the printing operation (S01). In particular, the controller 9 determines the open/closed state of the rear cover 29 depending on the output from the open/close sensor 95, i.e., whether the open/close sensor 95 detects the rear cover 29 or not.

When the controller 9 determines that the rear cover 29 is at the open position in S01 (S01: Y), the controller 9 controls the second exhaust fan 72 so that the driving speed matches the stop V2D (S02).

On the other hand, when the controller 9 determines that the rear cover 29 is at the closed position in S01 (S01: N), the controller 9 controls the second exhaust fan 72 so that the second exhaust fan 72 operates regularly (S03). In this context, a regular operation of the second exhaust fan 72 refers to an operation in which the driving speed changes in a range between the low speed V2C and the high speed V2A in accordance with the board temperature Tcb, the main body inside temperature Tin, and the outside temperature Tout when executing the printing operation in the state where the rear cover 29 is open.

After controlling the operation of the second exhaust fan 72 so that the driving speed matches the stop V2D in S02, the controller 9 determines whether the printing operation is completed or not (S04). Further, after controlling the second exhaust fan 72 to operate regularly in S03, the controller 9 determines whether the printing operation is completed or not (S04).

When the controller 9 determines that the printing operation is completed in S04 (S04: Y), the controller 9 ends control of the printing operation of the second exhaust fan 72.

When the controller 9 determines that the printing operation is not completed in S04 (S04: N), the controller 9 returns to S01 and again determines whether the rear cover 29 is at the open position or the closed position.

After setting the driving speed of the second exhaust fan 72 to the stop V2D in S02, if the controller 9 determines again that the rear cover 29 is at the open position in S01, the controller 9 maintains the driving speed of the second exhaust fan 72 at the stop V2D.

On the other hand, after controlling the second exhaust fan 72 to operate regularly in S03, if the controller 9 determines that the rear cover 29 is at the open position in S01, the controller 9 switches the driving speed of the second exhaust fan 72 to the stop V2D.

That is, while the printing operation is being executed, when the open/closed position of the rear cover 29 changes from the closed position to the open position, the controller 9 switches from the state where the second exhaust fan 72 is operating regularly to the state where the second exhaust fan 72 operates at the driving speed of the stop V2D. Accordingly, even when the rear cover 29 is moved from the closed position to the open position during a printing operation, the heated air may be suppressed from flowing into the area below the fuser 60 in the main body housing 2.

### Operation Control of Intake Fan During Printing Operation

The controller 9 controls an operation of the intake fan 77 as follows when printing an image.

As shown in FIG. 9, when the controller 9 determines that the rear cover 29 is at the closed position while executing the printing operation, and when the controller 9 determines that the rear cover 29 is at the open position while executing the printing operation, the controller 9 controls the intake fan 77 to drive at the high speed V3A. According to this control, air suctioned by the intake fan 77 may be guided to the process unit PU, and the process unit PU may be cooled.

### Cool-Down Control

When a predetermined condition is satisfied, the controller 9 is capable of executing cool-down control for stopping a printing operation, thereby suppressing an increase of the temperature in the main body housing 2.

The condition for starting the cool-down control is satisfied when the board temperature Tcb becomes equal to or higher than a cool-down start temperature Tcb_on, when the main body inside temperature Tin becomes equal to or higher than a cool-down start temperature Tin_on, or when the outside temperature Tout becomes equal to or higher than a cool-down start temperature Tout_on. The cool-down start temperature Tin_on of the main body inside temperature Tin is an example of the predetermined body temperature. The cool-down start temperature Tcb_on of the board temperature Tcb is an example of the predetermined board temperature.

For example, the cool-down start temperature Tcb_on of the board temperature Tcb may be set to a temperature higher than the high temperature Tcb1. Further, for example, the cool-down start temperature Tin_on of the main body inside temperature Tin may be set to a temperature higher than the high temperature Tin1. Furthermore, for example, the cool-down start temperature Tout_on of the outside temperature Tout may be set to a temperature higher than the high temperature Tout1.

The cool-down start temperature Tcb_on of the board temperature Tcb may be set to, for example, 80 degrees C. The cool-down start temperature Tin_on of the main body inside temperature Tin may be set to, for example, 42 degrees C. The cool-down start temperature Tout_on of the outside temperature Tout may be set to, for example, 42.5 degrees C.

That is, the controller 9 starts the cool-down control when at least one of the following conditions is satisfied: Tcb >= Tcb_on, Tin >= Tin_on, or Tout >= Tout_on.

The controller 9 executes the cool-down control when the main body inside temperature Tin becomes equal to or higher than the cool-down start temperature Tin_on. Thus, the controller 9 may stop printing and lower the temperature inside the main body housing 2 when the temperature in the main body housing 2 is high. By this control, an excessive increase in temperature of the process unit PU in the main body housing 2 may be suppressed.

The controller 9 executes the cool-down control when the board temperature Tcb becomes equal to or higher than the cool-down start temperature Tcb_on. Thus, the controller 9 may stop printing and lower the temperature inside the main body housing 2 when the temperature of the power supply board 11 is high. By this control, an excessive increase in temperature of the power supply board 11 may be suppressed.

The controller 9 executes the cool-down control when the outside temperature Tout becomes equal to or higher than the cool-down start temperature Tout_on. Thus, the controller 9 may stop printing and lower the temperature inside the main body housing 2 when the temperature in the main body housing 2 is likely to increase due to an influence of the outside temperature Tout. By this control, an excessive increase in temperature in the main body housing 2 due to an influence of the outside temperature Tout may be suppressed.

Further, the controller 9 may cancel the cool-down control when a predetermined condition is satisfied after starting the cool-down control.

The condition for canceling the cool-down control is satisfied when the board temperature Tcb becomes lower than a cool-down cancellation temperature Tcb_off, the main body inside temperature Tin becomes lower than the cool-down cancellation temperature Tin_off, and the outside temperature Tout becomes lower than the cool-down cancellation temperature Tout_off.

That is, the controller 9 cancels the cool-down control when all of the following conditions are satisfied: Tcb < Tcb_off, Tin < Tin_on, and Tout < Tout_on.

The cool-down cancellation temperature Tcb_off of the board temperature Tcb may be set to, for example, 75 degrees C. The cool-down cancellation temperature Tin_off of the main body inside temperature Tin may be set to, for example, 41 degrees C. The cool-down cancellation temperature Tout_off of the outside temperature Tout may be set to, for example, 41.5 degrees C.

According to the image forming apparatus 1 of the present embodiment, when the state, in which the printing operation is being performed, is switched to the state, in which the cool-down control is executed, power supply to the fuser 60 is stopped, causing the temperature of the fuser 60 having been heated to the fusing temperature to decrease as time passes.

### Operation Control of First Exhaust Fan for Cool-down Control

As shown in FIG. 9, during the printing operation and when executing the cool-down control, if the controller 9 determines that the rear cover 29 is at the closed position, the controller 9 stops the printing operation to print the image on the sheet S and sets the driving speed of the first exhaust fan 71 to the high speed V1A.

By setting the driving speed of the first exhaust fan 71 to the high speed V1A when executing the cool-down control in the state where the rear cover 29 is closed, the temperature in the main body housing 2 including the process unit PU may be lowered effectively.

On the other hand, during the printing operation and when executing the cool-down control, if the controller 9 determines that the rear cover 29 is at the open position, the controller 9 stops the printing operation on the sheet S and sets the driving speed of the first exhaust fan 71 to the low speed V1C which is lower than the high speed V1A.

By setting the driving speed of the first exhaust fan 71 to the low speed V1C when executing the cool-down control in the state where the rear cover 29 is open, the controller 9 may reduce a flow rate of the heated air flowing into the main body housing 2 and suppress an increase of the temperature in the main body housing 2.

In the present embodiment, when executing the cool-down control in the state where the rear cover 29 is open, the controller 9 sets the driving speed of the first exhaust fan 71 to the low speed V1C, but the controller 9 may optionally control the driving speed of the first exhaust fan 71 to a speed other than the low speed V1C as long as the speed is lower than the high speed V1A. Even in this setting, a flow rate of the heated air flowing into the main body housing 2 may be reduced, and an increase in temperature of the main body housing 2 may be suppressed.

Thus, as the cool-down control, the controller 9 stops the printing operation on the sheet S, and when the rear cover 29 is in the closed state, the controller 9 sets the driving speed of the first exhaust fan 71 to the high speed V1A; or when the rear cover 29 is in the open state, the controller 9 sets the driving speed of the first exhaust fan 71 to a speed lower than the high speed V1A. By this control, when executing the cool-down control, the controller 9 may suppress the flow of the heated air into the main body housing 2 while exhausting the air from the inside of the main body housing 2 reliably.

### Operation Control of Second Exhaust Fan for Cool-Down Control

As shown in FIG. 9, during the printing operation and when executing the cool-down control, if the controller 9 determines that the rear cover 29 is at the closed position, the controller 9 stops the printing operation to print the image on the sheet S and sets the driving speed of the second exhaust fan 72 to the high speed V2A.

By setting the driving speed of the second exhaust fan 72 to the high speed V2A when executing the cool-down control in the state where the rear cover 29 is closed, the temperature in the main body housing 2 including the process unit PU may be lowered effectively.

On the other hand, during the printing operation and when executing the cool-down control, if the controller 9 determines that the rear cover 29 is at the open position, the controller 9 stops the printing operation on the sheet S and sets the driving speed of the second exhaust fan 72 to the low speed V2C which is lower than the high speed V2A.

By setting the driving speed of the second exhaust fan 72 to the low speed V2C when executing the cool-down control in the state where the rear cover 29 is open, the air heated by the fuser 60 may be suppressed from flowing into the area below the fuser 60 in the main body housing 2, and the controller 9 may suppress an increase of the temperature in the main body housing 2.

In the present embodiment, when executing the cool-down control in the state where the rear cover 29 is open, the controller 9 sets the driving speed of the second exhaust fan 72 to the low speed V2C, but the controller 9 may optionally control the driving speed of the second exhaust fan 72 to a speed other than the low speed V2C as long as the speed is lower than the high speed V2A. Even in this setting, the air heated by the fuser 60 may be suppressed from flowing into the area below the fuser 60 in the main body housing 2, and an increase in temperature of the main body housing 2 may be suppressed.

Thus, as the cool-down control, the controller 9 stops the printing operation on the sheet S, and when the rear cover 29 is in the closed state, the controller 9 sets the driving speed of the second exhaust fan 72 to the high speed V2A; or when the rear cover 29 is in the open state, the controller 9 sets the driving speed of the second exhaust fan 72 to a speed lower than the high speed V2A. By this control, when executing the cool-down control, the controller 9 may suppress the air heated by the fuser 60 from flowing into the area below the fuser 60 in the main body housing 2 while exhausting the air from the inside of the main body housing 2 reliably.

Further, during a printing operation in the state where the rear cover 29 is at the open position, the controller 9 sets the driving speed of the second exhaust fan 72 to the stop V2D. Therefore, when the cool-down control is started during the printing operation in the state where the rear cover 29 is at the open position, the driving speed of the second exhaust fan 72 is switched from the stop V2D to the low speed V2C by the controller 9.

For example, the controller 9 may switch the driving speed of the second exhaust fan 72 from the stop V2D to the low speed V2C after a first time period TM has elapsed from the start of the cool-down control.

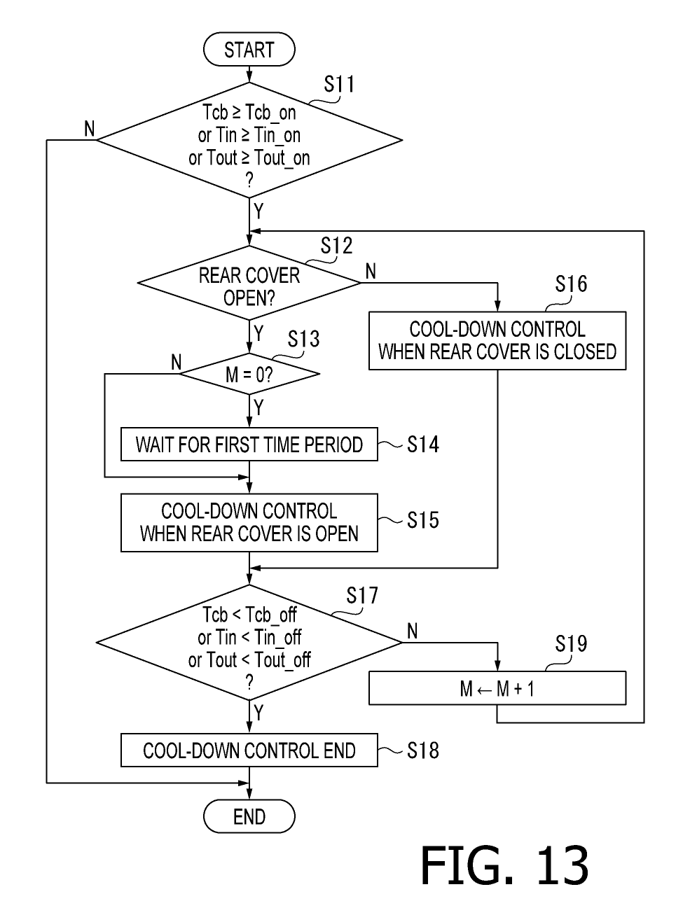

As shown in FIG. 13, the controller 9 determines whether or not at least one of the following conditions is satisfied during the printing operation: Tcb >= Tcb_on, Tin >= Tin_on, or Tout >= Tout_on (S11). If the controller 9 determines that at least one of the conditions of Tcb >= Tcb_on, Tin >= Tin_on, or Tout >= Tout_on is satisfied in S11 (S11: Y), the controller 9 executes the cool-down control. Note that during a printing operation in the state where the rear cover 29 is at the open position, the driving speed of the second exhaust fan 72 has been set to the stop V2D.

In S11, if the controller 9 determines that none of the conditions of Tcb >= Tcb_on, Tin >= Tin_on, or Tout >= Tout_on is satisfied (S11: N), the controller 9 ends the process without executing the cool-down control. According to the present embodiment, S11 is executed at a predetermined interrupt timing during the printing operation.

If the controller 9 determines that at least one of the conditions of Tcb >= Tcb_on, Tin >= Tin_on, or Tout >= Tout_on is satisfied in S11 (S11: Y), the controller 9 determines whether or not the rear cover 29 is at the open position (S12).

If the controller 9 determines that the rear cover 29 is at the open position in S12 (S12: Y), the controller 9 further determines whether a counter value M stored in the controller 9 is zero (S13). Note that the counter value M is set to zero (M=0) before the controller 9 first determines whether or not the rear cover 29 is at the open position.

If the controller 9 determines that the counter value M is zero (M=0), in S13 (S13: Y), the controller 9 waits for the first time period TM (S14) and thereafter executes the cool-down control for the case where the rear cover 29 is in the open state (S15). In the cool-down control in S15, the controller 9 controls the second exhaust fan 72 having been operated at the driving speed of the stop V2D to drive at the low speed V2C. In other words, the driving speed of the second exhaust fan 72 is switched from the stop V2D to the low speed V2C.

On the other hand, if the controller 9 determines that the rear cover 29 is at the closed position in S12 (S12: N), the controller 9 executes the cool-down control for the case where the rear cover 29 is in the closed state (S16). In the cool-down control in S16, the controller 9 controls the second exhaust fan 72 having been operated at the driving speed of the stop V2D to drive at the high speed V2A. In other words, the driving speed of the second exhaust fan 72 is switched from the stop V2D to the high speed V2A.

After executing the cool-down control in S14 or the cool-down control in S16, the controller 9 executes S17. In S17, the controller 9 determines whether all of the conditions of Tcb < Tcb_off, Tin < Tin_on, and Tout < Tout_on are satisfied.

If the controller 9 determines that not all of the conditions of Tcb < Tcb_off, Tin < Tin_on, and Tout < Tout_on are satisfied in S17 (S17: N), the controller 9 again determines whether the rear cover 29 is at the open position in S12. In S19, the controller 9 increments the counter value M by one (M←M+1).

If the controller 9 determines that the rear cover 29 is at the open position in S12 again (S12: Y), the controller 9 next determines whether the counter value M stored in the controller 9 is zero (S13).

In this flow, the counter value M has the value M+1 through S19; therefore, the controller 9 determines that the counter value M is not zero in S13 (S13: N). After determining that the counter value M is not zero in S13, the controller 9 executes the cool-down control for the case where the rear cover 29 is at the open state without waiting (S15).

If the controller 9 determines that all of the conditions of Tcb < Tcb_off, Tin < Tin_on, and Tout < Tout_on are satisfied in S17 (S17: Y), the controller 9 cancels the cool-down control (S18).

As such, when the cool-down control is executed during a printing operation in the state where the rear cover 29 is open, after the first time period TM has elapsed from the start of the cool-down control, the controller 9 sets the driving speed of the second exhaust fan 72 to the low speed V2C which is a speed higher than the stop V2D.

In the state where the rear cover 29 is open, when the image forming apparatus 1 shifts from the state where the printing operation is executed to the state where the cool-down control is executed, power supply to the fuser 60 is stopped and the first exhaust fan 71 is driven at the low speed V1C. Accordingly, the temperature of the fuser 60 decreases from the fusing temperature as the time passes.

Therefore, after the first time period TM has elapsed from the start of the cool-down control, the driving speed of the second exhaust fan 72 is changed from the stop V2D to the low speed V2C, causing the second exhaust fan 72 to be driven after the temperature of the fuser 60 is lowered to some extent. Accordingly, the flow of high-temperature air into the main body housing 2 may be suppressed.

### Operation Control of Intake Fan for Cool-Down Control

For executing the cool-down control during a printing operation, the controller 9 stops the printing operation on the sheet S and further controls an operation of the intake fan 77 as follows.

As shown in FIG. 9, during the printing operation and when executing the cool-down control, if the controller 9 determines that the rear cover 29 is at the closed position, the controller 9 controls the intake fan 77 to drive at the high speed V3A. By this control, the air suctioned by the intake fan 77 may be guided to the process unit PU, and the process unit PU may be cooled.

### Operation Control of First Exhaust Fan in Standby State

The image forming apparatus 1 enters a standby state at a time of starting up or after completion of a printing operation under control of the controller 9. When the image forming apparatus 1 is in the standby state, the controller 9 controls the temperature of the fuser 60 to remain at a standby temperature, which is lower than the fusing temperature.

The controller 9 controls the first exhaust fan 71 as follows when the image forming apparatus 1 is in the standby state.

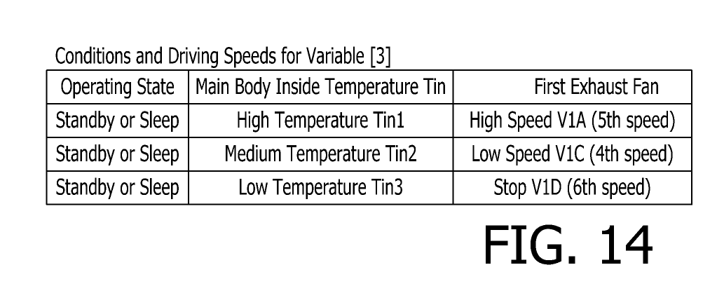

As shown in FIGS. 9 and 14, when the controller 9 determines that the rear cover 29 is at the closed position while the image forming apparatus 1 is in the standby state, the controller 9 controls the operation of the first exhaust fan 71 so as to change the driving speed in accordance with the main body inside temperature Tin (condition of variable 3 in FIG. 14).

Specifically, when the main body inside temperature Tin is the high temperature Tin1, the controller 9 sets the driving speed of the first exhaust fan 71 to the high speed V1A. When the main body inside temperature Tin is the medium temperature Tin2, the controller 9 sets the driving speed of the first exhaust fan 71 to the low speed V1C. When the main body inside temperature Tin is the low temperature Tin3, the controller 9 sets the driving speed of the first exhaust fan 71 to the stop V1D.

When the main body inside temperature Tin is the high temperature Tin1 which is higher than the medium temperature Tin2 and the low temperature Tin3, by setting the driving speed of the first exhaust fan 71 to the high speed V1A which is higher than the low speed V1C, the temperature in the main body housing 2 including the process unit PU may be lowered effectively.

Note that, in the present embodiment, the controller 9 sets the driving speed of the first exhaust fan 71 to the high speed V1A when the main body inside temperature Tin is the high temperature Tin1, but the driving speed in this occasion is not limited to this. That is, when the main body inside temperature Tin is the high temperature Tin1, the controller 9 may set the driving speed of the first exhaust fan 71 to a speed between the high speed V1A and the low speed V1C and higher than the low speed V1C.

When the main body inside temperature Tin is the medium temperature Tin2, the controller 9 sets the driving speed of the first exhaust fan 71 to the low speed V1C, but the driving speed in this occasion is not limited to this. That is, when the main body inside temperature Tin is the medium temperature Tin2, the controller 9 may set the driving speed of the first exhaust fan 71 to a speed equal to or lower than the driving speed of the first exhaust fan 71 in the case where the temperature is the high temperature Tin1 and equal to or higher than the low speed V1C in the case where the temperature is the high temperature Tin1.

When the main body inside temperature Tin is the low temperature Tin3, the controller 9 sets the driving speed of the first exhaust fan 71 to the stop V1D, but the driving speed in this occasion is not limited to this. That is, when the main body inside temperature Tin is the low temperature Tin3, the controller 9 may set the driving speed of the first exhaust fan 71 to a speed equal to or lower than the driving speed of the first exhaust fan 71 in the case where the temperature is the medium temperature Tin2 and equal to or higher than the stop V1D in the case where the temperature is the medium temperature Tin2.

On the other hand, when the controller 9 determines that the rear cover 29 is at the open position while the image forming apparatus 1 is in the standby state, the controller 9 controls the first exhaust fan 71 in the same manner as the control when the controller 9 determines that the rear cover 29 is at the closed position.

### Operation Control of Second Exhaust Fan in Standby State

The controller 9 controls the second exhaust fan 72 as follows when the image forming apparatus 1 is in the standby state.

As shown in FIG. 9, while the image forming apparatus 1 is in the standby state, both when the controller 9 determines that the rear cover 29 is at the closed position, and when the controller 9 determines that the rear cover 29 is at the open position, the controller 9 controls the second exhaust fan 72 to operate at the driving speed of the stop V2D. By this control, power consumption of the image forming apparatus 1 may be suppressed.

### Operation Control of Intake Fan in Standby State

The controller 9 controls the intake fan 77 as follows when the image forming apparatus 1 is in the standby state.

As shown in FIG. 9, both when the controller 9 determines that the rear cover 29 is at the closed position and when the controller 9 determines that the rear cover 29 is at the closed position while the image forming apparatus 1 is in the standby state, the controller 9 controls the intake fan 77 to drive at the high speed V3A. By this control, the air suctioned by the intake fan 77 may be guided to the process unit PU, and the process unit PU may be cooled.

### Operation Control of First Exhaust Fan in Sleep State

The image forming apparatus 1 shifts to a sleep state if there is no printing command given for a predetermined period of time after entering the standby state. When the image forming apparatus 1 is in the sleep state, the controller 9 stops power supply to the fuser 60. By this control, the temperature of the fuser 60 decreases to a temperature lower than the standby temperature.

The controller 9 controls the first exhaust fan 71 as follows when the image forming apparatus 1 is in the sleep state.

As shown in FIGS. 9 and 14, when the controller 9 determines that the rear cover 29 is at the closed position while the image forming apparatus 1 is in the sleep state, the controller 9 controls the operation of the first exhaust fan 71 so as to change the driving speed in accordance with the main body inside temperature Tin (condition of variable 3 in FIG. 14).

Specifically, when the main body inside temperature Tin is the high temperature Tin1, the controller 9 sets the driving speed of the first exhaust fan 71 to the high speed V1A. When the main body inside temperature Tin is the medium temperature Tin2, the controller 9 sets the driving speed of the first exhaust fan 71 to the low speed V1C. When the main body inside temperature Tin is the low temperature Tin3, the controller 9 sets the driving speed of the first exhaust fan 71 to the stop V1D.

When the main body inside temperature Tin is the high temperature Tin1 which is higher than the medium temperature Tin2 and the low temperature Tin3, by setting the driving speed of the first exhaust fan 71 to the high speed V1A which is higher than the low speed V1C, the temperature in the main body housing 2 including the process unit PU may be lowered effectively.

Note that, in the present embodiment, the controller 9 sets the driving speed of the first exhaust fan 71 to the high speed V1A when the main body inside temperature Tin is the high temperature Tin1, but the driving speed in this occasion is not limited to this. That is, when the main body inside temperature Tin is the high temperature Tin1, the controller 9 may set the driving speed of the first exhaust fan 71 to a speed between the high speed V1A and the low speed V1C and higher than the low speed V1C.

When the main body inside temperature Tin is the medium temperature Tin2, the controller 9 sets the driving speed of the first exhaust fan 71 to the low speed V1C, but the driving speed in this occasion is not limited to this. That is, when the main body inside temperature Tin is the medium temperature Tin2, the controller 9 may set the driving speed of the first exhaust fan 71 to a speed equal to or lower than the driving speed of the first exhaust fan 71 in the case where the temperature is the high temperature Tin1 and equal to or higher than the low speed V1C in the case where the temperature is the high temperature Tin1.

When the main body inside temperature Tin is the low temperature Tin3, the controller 9 sets the driving speed of the first exhaust fan 71 to the stop V1D, but the driving speed in this occasion is not limited to this. That is, when the main body inside temperature Tin is the low temperature Tin3, the controller 9 may set the driving speed of the first exhaust fan 71 to a speed equal to or lower than the driving speed of the first exhaust fan 71 in the case where the temperature is the medium temperature Tin2 and equal to or higher than the stop V1D in the case where the temperature is the medium temperature Tin2.

On the other hand, when the controller 9 determines that the rear cover 29 is at the open position while the image forming apparatus 1 is in the sleep state, the controller 9 controls the first exhaust fan 71 in the same manner as the control when the controller 9 determines that the rear cover 29 is at the closed position.

### Operation Control of Second Exhaust Fan in Sleep State

The controller 9 controls the second exhaust fan 72 as follows when the image forming apparatus 1 is in the sleep state.

As shown in FIG. 9, while the image forming apparatus 1 is in the sleep state, both when the controller 9 determines that the rear cover 29 is at the closed position, and when the controller 9 determines that the rear cover 29 is at the open position, the controller 9 controls the second exhaust fan 72 to operate at the driving speed of the stop V2D. By this control, power consumption of the image forming apparatus 1 may be suppressed.

### Operation Control of Intake Fan in Sleep State

The controller 9 controls the intake fan 77 as follows when the image forming apparatus 1 is in the sleep state.

As shown in FIG. 9, both when the controller 9 determines that the rear cover 29 is at the closed position and when the controller 9 determines that the rear cover 29 is at the closed position while the image forming apparatus 1 is in the sleep state, the controller 9 controls the intake fan 77 to operate at the driving speed of the stop V3D. By this control, power consumption of the image forming apparatus 1 may be suppressed.

While the present disclosure described in conjunction with the example structure outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, is intended to be illustrative of the disclosure, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. An image processing apparatus, comprising:
a main body housing including an opening;
a cover configured to open and close the opening;
a process unit including a photosensitive drum configured to rotate about an axis and a developing device configured to supply a toner to the photosensitive drum, the process unit being configured to form an image with the toner on a sheet;
a fuser located between the cover and the process unit in a view along an axial direction of the photosensitive drum, the fuser being configured to heat the sheet, on which the image is formed with the toner, to fix the image onto the sheet;
a first exhaust fan configured to exhaust air in the main body housing, the first exhaust fan being located at an upper position with respect to the fuser in the view along the axial direction;
a second exhaust fan configured to exhaust air in the main body housing, the second exhaust fan being located at a lower position with respect to the fuser in the view along the axial direction; and
a controller configured to execute a printing operation for forming the image on the sheet, the controller being configured to:
control the second exhaust fan to drive at a driving speed equal to or higher than a first speed when executing the printing operation in a state where the cover is closed; and
control the second exhaust fan to drive at a second speed lower than the first speed when executing the printing operation in a state where the cover is open.

2. The image forming apparatus according to claim 1, wherein the second speed is zero.

3. The image forming apparatus according to claim 1, further comprising a board located at a position to overlap the second exhaust fan in the view along the axial direction,
wherein the controller is configured to change the driving speed of the second exhaust fan within a range between the first speed and a third speed higher than the first speed according to a temperature of the board.

4. The image forming apparatus according to claim 3,
wherein the controller is configured to execute cool-down control for suppressing an increase of a temperature inside the main body housing by:
stopping the printing operation on the sheet; and
controlling the second exhaust fan to drive at one of:
the third speed, in a case of the state where the cover is closed; and
a driving speed lower than the third speed, in a case of the state where the cover is open.

5. The image forming apparatus according to claim 4, wherein the controller is configured to, when the controller executes the cool-down control in the state where the cover is open, control the second exhaust fan to drive at a driving speed higher than the second speed after a first time period elapses from starting of the cool-down control.

6. The image forming apparatus according to claim 4, wherein the controller is configured to execute the cool-down control in a case where the temperature inside the main body housing is equal to or higher than a predetermined housing temperature.

7. The image forming apparatus according to claim 4,
wherein a sensor configured to detect the temperature of the board is mounted on the board, and
wherein the controller is configured to execute the cool-down control in a case where the temperature of the board detected by the sensor is equal to or higher than a predetermined board temperature.

8. The image forming apparatus according to claim 1, wherein the controller is configured to:
when executing the printing operation in the state where the cover is closed, control the first exhaust fan to drive at a driving speed changed within a range between a third speed and a fourth speed higher than the third speed according to a temperature inside the main body housing, and
when executing the printing operation in the state where the cover is open, control the first exhaust fan to drive at the third speed.

9. The image forming apparatus according to claim 1, further comprising:
an intake fan configured to draw air into the main body housing; and
a duct configured to guide the air drawn into the main body housing by the intake fan to the process unit along the axial direction.

10. The image forming apparatus according to claim 1, wherein the cover includes a sheet tray configured to support the sheet discharged from the main body housing in the state where the cover is open.
